(19) United States
(12) Patent Application Publication
(10) Pub. No.: US 2010/0133115 A1
(43) Pub. Date: Jun. 3, 2010

(54) DEVICES AND METHODS FOR ACID AND BASE GENERATION

(75) Inventor: Joseph D. Gifford, Marlborough, MA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS WATER TECHNOLOGIES CORP., Warrendale, PA (US)

(21) Appl. No.: 12/530,821

(22) PCT Filed: Mar. 13, 2008
(86) PCT No.: PCT/US08/03284

§ 371 Date: Feb. 5, 2010

Related U.S. Application Data
(60) Provisional application No. 60/894,519, filed on Mar. 13, 2007.

(51) Int. Cl. C02F 1/461; C25B 9/00

(52) U.S. Cl. 205/746; 204/252; 204/263; 205/742

(57) ABSTRACT

Electrochemical devices and methods for acid and base generation are disclosed. A source of purified water is fluidly connected to at least one compartment of the device. A source of an ionic species, such as an acid or base precursor, is also provided to at least one compartment of the device. An applied electrical field promotes ion transport across selective membranes which at least partially define the compartments. The purified water may be dissociated into hydronium and hydroxyl ions in an electrolyzing compartment of the device. Acid and/or base product streams may be recovered as desired at outlets of the various compartments. In some embodiments, a bipolar membrane may be used to split water in place of the electrolyzing compartment.

### FIELD OF THE TECHNOLOGY

The present invention relates generally to electrochemical techniques and, more particularly, to electrochemical devices and methods for acid and base generation.

### BACKGROUND

Devices capable of treating liquid streams with an applied electrical field to remove undesirable ionic species therein are known. These electrically-motivated separation apparatus including, but not limited to, electrodialysis and electrodeionization devices are conventionally used to generate purified water, such as deionized (DI) water.

Within these devices are concentrating and diluting compartments separated by ion-selective membranes. An electrodeionization device typically includes alternating electroactive semipermeable anion and cation exchange membranes. Spaces between the membranes are configured to create liquid flow compartments with inlets and outlets. The compartments typically contain adsorption media, such as ion exchange resin, to facilitate ion transfer. An applied electric field imposed via electrodes causes dissolved ions, attracted to their respective counter-electrodes, to migrate through the anion and cation exchange membranes. This generally results in the liquid of the diluting compartment being depleted of ions, and the liquid in the concentrating compartment being enriched with the transferred ions. Typically, the liquid in the diluting compartment is desired (the “product” liquid), while the liquid in the concentrating compartment is discarded (the “reject” liquid).

### SUMMARY

Aspects relate generally to electrochemical devices and methods for acid and base generation.

In accordance with one or more aspects, an electrochemical device may comprise a first concentrating compartment at least partially defined by a first anion-selective membrane and a second anion-selective membrane, an electrolyzing compartment at least partially defined by the second anion-selective membrane and a cation-selective membrane, and a second concentrating compartment at least partially defined by the cation-selective membrane and a third anion-selective membrane.

In accordance with one or more aspects, an electrochemical device may comprise a first concentrating compartment at least partially defined by a first cation-selective membrane and a second cation-selective membrane, a second concentrating compartment at least partially defined by the second cation-selective membrane and an anion-selective membrane, and an electrolyzing compartment at least partially defined by the anion-selective membrane and a third cation-selective membrane.

In accordance with one or more embodiments, a method of operating an electrochemical device may comprise introducing a cationic species and an anionic species into a first concentrating compartment of the electrochemical device, introducing deionized water into a second concentrating compartment and a depleting compartment of the electrochemical device, electrolyzing deionized water in the depleting compartment, and recovering an acid stream at an outlet of the first concentrating compartment.

Still other aspects, embodiments, and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures. In the figures, which are not intended to be drawn to scale, each identical or nearly identical component that is illustrated in various figures is represented by a like numeral. For purposes of clarity, not every component may be labeled in every drawing. The figures are provided for the purposes of illustration and explanation and are not intended as a definition of the limits of the invention. In the figures:

FIG. 1 illustrates an electrochemical device in accordance with one or more embodiments;

FIG. 2 illustrates an electrochemical device in accordance with one or more embodiments;

FIG. 3 illustrates an electrochemical device in accordance with one or more embodiments;

FIGS. 4A-4E illustrate various system plumbing configurations as discussed in an accompanying Example;

FIGS. 5A and 5B present tables summarizing test conditions and results as discussed in an accompanying Example;

FIGS. 6A-6E present electrodeionization module power charts as discussed in an accompanying Example; and

FIGS. 7A and 7B present data relating to effect of electrical current as discussed in an accompanying Example.

### DETAILED DESCRIPTION

One or more embodiments relates generally to electrochemical devices and methods. The devices and methods may be effective in generating acid and/or base streams. In-situ generation techniques described herein may be implemented in a wide variety of applications in which use of an acid or base is required, but storage and/or handling thereof is undesirable. Embodiments may also be implemented to recover and purify an acid or base from a mixture with one or more other components. Embodiments of the disclosed devices and methods may further be implemented to alter a pH level of a process stream. Thus, less pH correction, for example via chemical addition, may be required to effect any desired neutralization or pH adjustment. At least one embodiment may be efficient in generating an acid and/or a base without using a bipolar membrane. Beneficially, certain embodiments may be used to generate a reactant stream of sufficient strength and quality to be delivered to an upstream or downstream application.

It is to be appreciated that embodiments of the systems and methods discussed herein are not limited in application to the details of construction and the arrangement of components set forth in the following description or illustrated in the accompanying drawings. The systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

Devices and methods in accordance with one or more embodiments may generally be implemented to generate acid and/or base streams from ionic species. In at least some embodiments, devices and methods may concentrate an acid and/or a base as a product. In some embodiments, devices and methods may generally involve electrical separation techniques. Devices and methods may be used to separate or purify acid and/or base streams from mixtures. Devices and methods may also be applicable to adjusting a pH level of a process stream. Some embodiments also pertain to methods of manufacture, promotion, and use of such methods, systems, and devices. The electrochemical devices may be operated in any suitable fashion that achieves the desired product and/or effects the desired treatment. For example, the various embodiments of the invention can be operated continuously, or essentially continuously or continually, intermittently, periodically, or even upon demand. An electrical separation device may be operatively associated with one or more other units, assemblies, and/or components. Ancillary components and/or subsystems may include pipes, pumps, tanks, sensors, control systems, as well as power supply and distribution subsystems that cooperatively allow operation of the system.

An electrochemical device, such as an electrodeionization device, is generally able to separate one or more components of a liquid, for example, ions dissolved and/or suspended therein, by using an electrical field to influence and/or induce transport or otherwise provide mobility of the dissolved and/or suspended species in the liquid thereby at least partially effecting separation, or removal, of the species from the liquid. The one or more species in the liquid can be considered, with respect to certain aspects, a “target” species.

In accordance with one or more embodiments, and as discussed in greater detail herein, a process stream may be introduced to at least one compartment of an electrochemical device. The process stream may contain one or more target species or target ions. The target species may be a precursor to an acid or base product. The process stream may be a source of an acid or base precursor. The precursor may comprise one or more ions, generally present in the process stream. In at least some embodiments, the ions may be dissociated in the process stream. In some embodiments, the process stream may generally comprise a salt solution. A source of water, such as purified water or deionized water, may also be introduced to at least one compartment of the electrochemical device. In some embodiments, the water may be supplied to one or more compartments other than those to which a process stream is supplied. In other embodiments, they may be supplied to one or more of the same compartments. An applied electric field may promote dissociation of the water into hydrogen or hydronium ions, as well as hydroxyl ions. The applied electric field may also promote migration of one or more ions within the electrochemical device. The hydrogen, hydroxyl and/or precursor ions may migrate. Ionic migration may be across one or more ion-selective membranes of the electrochemical device. Ions may be concentrated or trapped in one or more compartments, for example, based on their charge or nature. For example, an acidic product may become concentrated in one compartment, and a basic product may become concentrated in another compartment. The orientation and nature of various ion-selective membranes within the electrochemical device may influence migration therein as well as what type of products may be formed in the various compartments. Streams of generated products may exit the electrochemical device via outlets associated with the various compartments, for example, an acidic solution outlet and/or a basic solution outlet.

In accordance with one or more embodiments, an acid or base generating system may include one or more electrochemical devices. Non-limiting examples of electrical separation devices, or electrically-driven separation apparatus, include electrodialysis and electrodeionization devices. The term “electrodeionization” is given its ordinary definition as used in the art. Typically within these exemplary devices are concentrating and diluting compartments separated by media having selective permeability, such as anion-selective and cation-selective membranes. In these devices, the applied electric field causes ionizable species, dissolved ions, to migrate through the selectively permeable media, i.e., anion-selective and cation-selective membranes, resulting in the liquid in the diluting compartment being depleted of ions, and the liquid in the concentrating compartment being enriched with the migrant, transferred ions. An electrodeionization device may include solid “media” (e.g., electro-active media or adsorption media, such as ion exchange media) in one or more compartments within the device. The electro-active media typically provides a path for ion transfer, and/or serve as an increased conductivity bridge between the selective membranes to facilitate movement of ions within compartments of the device. The media is generally able to collect or discharge ionic and/or other species, e.g. by adsorption/desorption mechanisms. The media may carry permanent and/or temporary electrical charge, and can operate, in some instances, to facilitate electrochemical reactions designed to achieve or enhance performance of the electrodeionization device, e.g., separation, chemisorption, physisorption, and/or separation efficiency. Examples of media that may be utilized in accordance with some embodiments of the invention include, but are not limited to, ion exchange media in formats such as particles, fibers, and membranes. Such materials are known in the art and are readily commercially available. Combinations of any of the above-mentioned formats may be utilized in any one or more of the various embodiments of the invention. In some embodiments, the electrochemical device may comprise one or more electrodeionization units. In at least one embodiment, the electrochemical device may consist essentially of one or more electrodeionization units.

In accordance with one or more embodiments, a process stream may be supplied to one or more compartments of the electrochemical device. The process stream may include one or more target species. A target species may generally be any species that is dissolved and/or suspended in a process fluid, typically a liquid, which is desired to be removed or transferred from a first solution to another solution, typically using an electrical separation device. Examples of target species that are desirably removed or transported between solutions using electrical separation devices may include certain ionic species, organic molecules, weakly ionized substances, and ionizable substances in the operating environment within the device. Target ionic species that are desirably removed or transported in accordance with some aspects of the invention can be one or more ions able to precipitate from solution, and/or are able to react with other species and/or ions in a solution to form salts and/or other compounds that are able to precipitate from solution. Non-limiting examples of target ionic species can include Ca²⁺, Mg²⁺, Si⁴⁺, Cu²⁺, Al³⁺, Fe³⁺, Mn²⁺, Pb³⁺, Pb⁴⁺, SO₄²⁻, SiO₄²⁻, and HCO₃⁻, as well as combinations of any two or more of these. In some embodiments, the target species may be a non-precipitatable species or soluble species under conditions during operation of the electrochemical device, generally referring to a species which can be an ionic component thereof that does not readily precipitate from solution, or react with other species and/or ions in a solution to form salts and/or other compounds that precipitate. For example, a non-inclusive list of non-precipitatable species include the ions, Na⁺, Cl⁻, K⁺, and H⁺. In some alternative embodiments, a target species may include calcium, carbonate and sulfate.

A process stream containing one or more target ions may be processed with devices and methods in accordance with one or more embodiments. Isolation and conversion of one or more target ions may be desirable as discussed herein. For example, the target ions in the process stream may be manipulated by the devices and methods to form a product stream of value or otherwise desirable. In some embodiments, the devices and methods may isolate target ions and use them to form or generate a target compound. Thus, the target ions present in the process stream may be precursors of a target compound. In some embodiments, a target ion may be a precursor to a desired acid or base product. In at least one embodiment, the process stream may be an aqueous solution, such as a salt solution. The salt solution, or ions thereof, may be a precursor to a desired acid or base product. In some embodiments, target ions may generally be dissociated in the process stream. In accordance with one or more embodiments, the process stream may provide a source of ionic species, such as a first cationic species and a first anionic species. The first cationic species and/or the first anionic species may be precursors to a product acid or product base, respectively, or vice versa.

In accordance with one or more embodiments, it may be desirable to generate acid and base target compounds. Acids and/or bases may be products of the electrochemical devices and methods. Acid and/or base product streams may be generated by the electrochemical devices and methods. In at least one embodiment, acid and/or base products may be concentrated by the electrochemical devices and methods. In some embodiments, the target compound to be generated may be a caustic compound, such as sodium hydroxide or ammonium sulfate. In other embodiments, the target compound to be generated may be an acid, such as hydrochloric acid. Any acid or base may be generated as a product stream from one or more target ions. Target ions in the process stream supplied to the electrochemical device may be selected based on a desired product stream.

Devices and methods may generally result in one or more product streams containing one or more target compounds. Generated target compounds may then be supplied upstream or downstream of the electrochemical device for use. In some embodiments, the target ions may be present in the process stream as a reactant byproduct due to upstream consumption of a consumable or reactant. In some embodiments, the target compound to be generated as a product may be the original consumable or reactant which gave rise to the target ion in the process stream.

In accordance with one or more embodiments, an aqueous solution to be processed may be introduced into an electrodeionization device from a source or point of entry. A conduit may serve as a manifold fluidly connecting a process stream source to one or more compartments of one or more electrodeionization devices. The source of process fluid may typically be fluidly connected to at least one depleting compartment and/or at least one concentrating compartment. The aqueous solution can be a salt solution comprising at least one soluble cationic species and/or at least one soluble anionic species as discussed above. Further embodiments of devices can also involve configurations with a source of a second solution, i.e., a second source of another aqueous solution, typically an aqueous solution that compositionally differs from the aqueous solution from the first source. The second source can provide, for example, a salt solution comprising a second cationic species and a second anion species. The second source may be fluidly connected to the same or different compartments than the first source. Of course, variants of these configurations are contemplated including, for example, a plurality of sources of solutions. Particular embodiments of the invention, however, contemplate configurations wherein one or more of the aqueous solutions comprise soluble or even non-precipitating species. For example, some embodiments involve a source of a salt solution, such as one comprising sodium and chloride ions.

In accordance with one or more embodiments, a source of treated or deionized (DI) water may be fluidly connected to one or more compartments of the electrochemical device. The treated or DI water may generally facilitate generation of acid and/or base products. The treated or DI water may provide a source of hydrogen, hydronium or hydroxyl ions for acid or base generation. One skilled in the art might not introduce DI water to an electrodialysis device due to a high resistivity to electrolyzing DI water. Treated or DI water may generally be supplied to one or more compartments other than those to which a process stream is being supplied. In other embodiments, they may be added to one or more of the same compartments. In some embodiments, the treated or DI water may be dissociated into hydrogen or hydronium and hydroxyl ions to facilitate acid or base generation by the electrochemical device. In some embodiments, the applied electric field in the electrodeionization device creates a polarization phenomenon, which typically promotes the dissociation of water into hydronium and hydroxyl ions. In accordance with one or more embodiments, this water splitting of the DI water may provide a source of a second anion and a source of a second cation. The electrochemical device may promote migration of ions such that the second anion and the second cation may associate with a first cation and a first anion, respectively, from the process stream to produce one or more desirable product streams as discussed herein. For example, a cation precursor ion in the process stream may pair with an anion from the DI water to produce a first product stream. An anion precursor ion in the process stream may pair with a cation from the DI water to produce a second product stream.

The treated or DI water can be provided by any source. In some cases, the treated or DI water can be provided by an electrically-driven apparatus or other source. The source of treated or DI water is not limited to self-produced water. External sources of treated or DI water may be used, or other sources of the second anion and the second cation, e.g., hydronium and hydroxyl species, can be used. The purity of the water supplied may depend on a variety of factors, for example, the intended application or a desired quality of product to be produced. In certain instances, purified or DI water having an electrical resistivity of greater than about 0.1 megohm-cm, greater than about 1 megohm-cm, greater than about 3 megohm-cm, greater than about 6 megohm-cm, greater than about 9 megohm-cm, greater than about 12 megohm-cm, greater than about 15 megohm-cm, or at least about 18 megohm-cm is used.

In accordance with one or more particular aspects, the invention can relate to methods, systems, and devices for inducing migration of components of ionized species such as minerals, salts, ions and organics under the influence of an applied force from a first liquid to a second liquid. For example, ions may migrate to or from supplied process fluid to supplied DI water to produce one or more product streams. In some aspects, liquid in a diluting compartment may be desired, i.e., a product, while the liquid in a concentrating compartment may be discarded as a reject. However, some aspects of the invention contemplate applications directed to retrieving ionized or even ionizable species, in a liquid stream, especially aqueous streams. For example, acidic and/or basic streams may be recovered as product streams. The acid and/or base may be generated from one or more precursor target ions. One or more such species may be recovered, for example, for reuse in an upstream unit operation or for use in a downstream unit operation. Thus, in some aspects, a liquid in one or more concentrating compartments may be desired as a product, as discussed further herein.

Some embodiments of the invention pertinent to, for example, treatment systems, may utilize one or more pre-treatment steps to reduce the concentration of species within the entering liquid that can cause, for example, scaling or fouling. Thus, embodiments directed to the systems and techniques of the invention may involve one or more pre-softening unit operations or steps. Thus, some pre-treatment systems and techniques may be directed to reducing the likelihood of forming scale. Embodiments directed to such aspects can rely on, for example, considerations related to physicochemical properties of hardness related species. A process stream and/or a DI water stream may be pre-treated accordingly. Between the point of entry and the electrodeionization device may be any number of operations or distribution networks that may operate on the liquid. For example one or more unit operations such as those involving reverse osmosis, filtration, such as microfiltration or nanofiltration, sedimentation, activated carbon filters, electrodialysis or electrodeionization devices may be included. In some embodiments, a liquid stream supplied to the electrochemical device may originate from a unit operation producing a liquid and/or operating on a liquid, such as, but not limited to, unit operations for ultrafiltration, nanofiltration, sedimentation, distillation, humidification, reverse osmosis, dialysis, extraction, chemical reactions, heat and/or mass exchange. In certain embodiments, a liquid may originate from a reservoir, such as a storage vessel, a tank, or a holding pond, or from a natural or artificial body of water.

In one or more embodiments pertinent to aspects directed to electrochemical separation techniques, electrically-driven separation devices may comprise one or more depleting compartments and one or more concentrating compartments. Compartments or cells may generally differ functionally with respect to the type, and/or composition of the fluid introduced therein. Structural differences, however, may also distinguish the various compartments. In some embodiments, a device may include one or more types of depleting compartments and one or more types of concentrating compartments. The nature of any given compartment, such as whether it is a concentrating or depleting compartment, may be generally informed by the types of membranes which border the compartment, as well as the type of feed(s) supplied to the compartment. The nature of neighboring compartments may influence each other. In some embodiments, a compartment may be an electrolyzing compartment. For example, a depleting compartment may be referred to as an electrolyzing compartment. In some embodiments, a concentrating compartment may also be referred to as an electrolyzing compartment. In some embodiments, water splitting may generally occur in an electrolyzing compartment. An electrolyzing compartment may be a water splitting cell. Other ionic interactions may also occur in an electrolyzing compartment.

Ion-selective membranes typically form borders between adjacent compartments. Thus, one or more compartments may be at least partially defined by one or more ion-selective membranes. A plurality of compartments is typically arranged as a stack in the electrochemical device. A depleting compartment is typically defined by a depleting compartment spacer and concentrating compartment is typically defined by a concentrating compartment spacer. An assembled stack is typically bound by end blocks at each end and is typically assembled using tie rods which may be secured with nuts. In certain embodiments, the compartments include cation-selective membranes and anion-selective membranes, which are typically peripherally sealed to the periphery of both sides of the spacers. The cation-selective membranes and anion-selective membranes typically comprise ion exchange powder, a polyethylene powder binder and a glycerin lubricant. In some embodiments, the cation- and anion-selective membranes are heterogeneous membranes. These may be polyolefin-based membranes or other type. They are typically extruded by a thermoplastic process using heat and pressure to create a composite sheet. In some embodiments, homogeneous membranes, such as those commercially available from Tokuyama Soda of Japan may be implemented. The one or more selectively permeable membranes may be any ion-selective membrane, neutral membrane, size-exclusive membrane, or even a membrane that is specifically impermeable to one or more particular ions or classes of ions. In some cases, an alternating series of cation- and anion-selective membranes is used within the electrically-driven apparatus. The ion-selective membranes may be any suitable membrane that can preferentially allow at least one ion to pass therethrough, relative to another ion.

In one embodiment, a plurality of depleting compartments and concentrating compartments can be bounded, separated or at least partially defined by one or more ion-selective membranes “c” and “a”. In some embodiments, ion-selective membranes a and c are arranged as an alternating series of cation-selective membranes (designated as “c”) that preferentially allow cations to pass therethrough, relative to anions; and anion-selective membranes (designated as “a”) that preferentially allow anions to pass therethrough, relative to cations. In other preferred embodiments, arrangements such as “c c a c” or “a a c a” may be employed, as discussed in greater detail below. Adjacent compartments may be considered to be in ionic communication therebetween, such as via a neighboring ion selective membrane. Distal compartments may also be considered to be in ionic communication, such as via additional compartments therebetween.

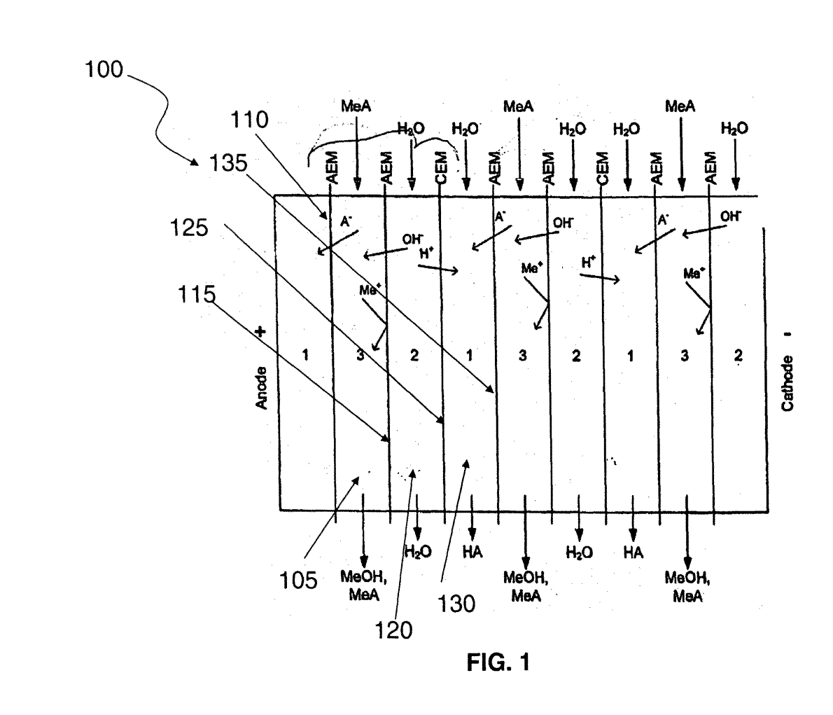

In accordance with one or more embodiments, with reference to FIG. 1, an electrochemical device 100 may comprise a first concentrating compartment 105 at least partially defined by a first anion-selective membrane 110 and a second anion-selective membrane 115. The device 100 may further comprise an electrolyzing compartment 120 at least partially defined by the second anion-selective membrane 115 and a cation-selective membrane 125. The device 100 may still further comprise a second concentrating compartment 130 at least partially defined by the cation-selective membrane 125 and a third anion-selective membrane 135.

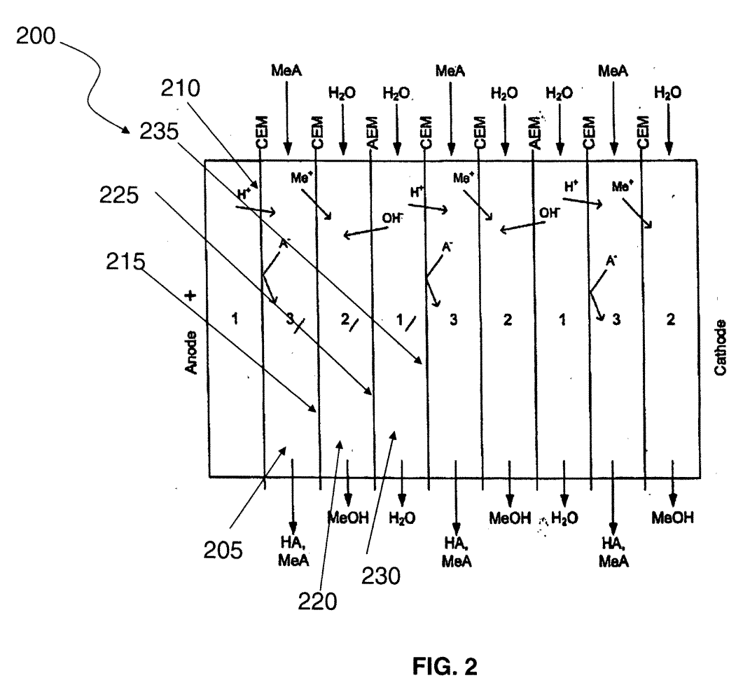

In accordance with one or more embodiments, with reference to FIG. 2, an electrochemical device 200 may comprise a first concentrating compartment 205 at least partially defined by a first cation-selective membrane 210 and a second cation-selective membrane 215. The device 200 may further include a second concentrating compartment 220 at least partially defined by the second cation-selective membrane 215 and an anion-selective membrane 225. The device 200 may still further include an electrolyzing compartment 230 at least partially defined by the anion-selective membrane 225 and a third cation-selective membrane 235.

In devices 100 or 200, the first concentrating, electrolyzing, and second concentrating compartments may form a grouping or set. Device 100 or 200 may have multiple or a plurality of such groupings or sets. In some embodiments, devices 100 or 200 may consist essentially of at least one first concentrating compartment, at least one electrolyzing compartment, and at least one second concentrating compartment.

In some embodiments, a source of an ionic species may be fluidly connected to one or more concentrating compartments or electrolyzing compartments. In at least one embodiment, a source of an ionic species may be fluidly connected to a first concentrating compartment. In some embodiments, a source of purified or DI water may be fluidly connected to one or more concentrating or electrolyzing compartments. In at least one embodiment, a source of purified or DI water may be fluidly connected to a second concentrating compartment and to an electrolyzing compartment. Other feed configurations may be implemented.

In at least one embodiment, one or more bipolar membranes may be incorporated to at least partially define one or more compartments. Bipolar membranes are generally anionic membranes on one side and cationic on the other. Bipolar membranes may be generally efficient in splitting water. In some embodiments, bipolar membranes can be used in the place of a water splitting cell. In some embodiments, one or more bipolar membranes may be used in conjunction with one or more anion and/or cation selective membranes. In accordance with one or more embodiments, an electrochemical device may include an alternating series of bipolar membranes and anion selective membranes. Likewise, an electrochemical device may include an alternating series of bipolar membranes and cation selective membranes in accordance with one or more embodiments. Those ordinarily skilled in the art would recognize that, in accordance with certain aspects of the invention, other types and/or arrangements of selective membranes can also be used. In at least one embodiment, an electrochemical device does not include a bipolar membrane.

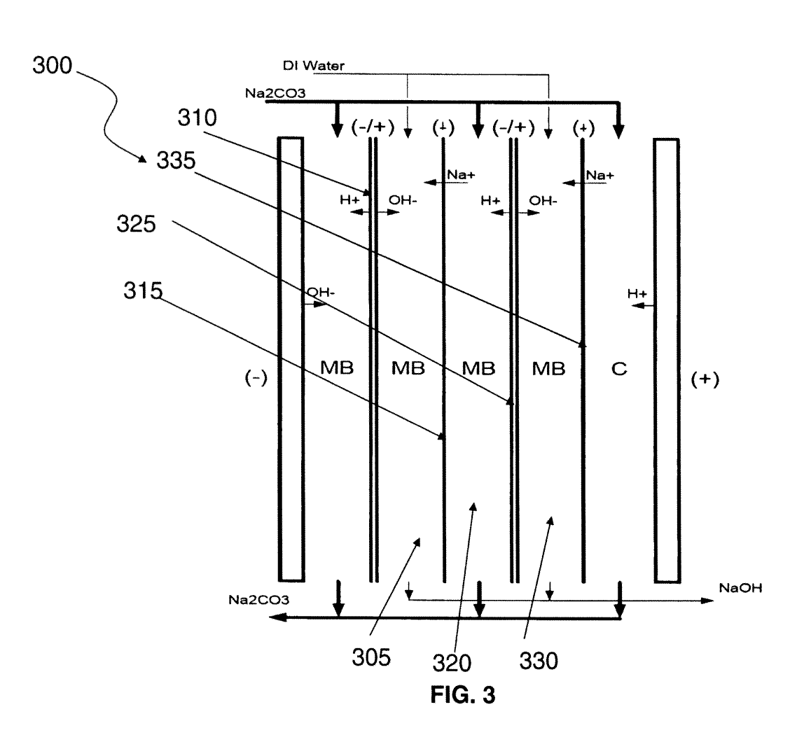

In accordance with one or more embodiments, with reference to FIG. 3, an electrochemical device 300 may comprise a first concentrating compartment 305 at least partially defined by a first bipolar membrane 310 and a first cation-selective membrane 315. The device 300 may further include a depleting compartment 320 at least partially defined by the first cation-selective membrane 315 and a second bipolar membrane 325. The device may further include a second concentrating compartment 330 at least partially defined by the second bipolar membrane 325 and a second cation-selective membrane 335. The combination of bipolar membrane and cation-selective membrane may be repeated any desired number of times as desired in device 300.

In some embodiments, a source of an ionic species may be fluidly connected to one or more concentrating compartments or electrolyzing compartments. In at least one embodiment, a source of an ionic species may be fluidly connected to a first concentrating compartment and a second concentrating compartment. In some embodiments, a source of purified or DI water may be fluidly connected to one or more electrolyzing or depleting compartments. In at least one embodiment, a source of purified or DI water may be fluidly connected to an electrolyzing compartment. In some embodiments, a bipolar membrane may at least partially define a base concentrating or aggregating compartment on one of its sides, and an acid concentrating or aggregating compartment on its other side. Other feed configurations may be implemented.

In accordance with one or more embodiments, typical configurations of the electrically-driven separation device include at least one electrode pair through which an applied force, such as an electric field, can facilitate transport or migration of the one or more ionic, or ionizable, species. The device can thus comprise at least one anode and at least one cathode. The electrodes may each independently be made out of any material suitable for creating an electric field within the device. In some cases, the electrode material can be chosen such that the electrodes can be used, for example, for extended periods of time without significant corrosion or degradation. Suitable electrode materials and configurations are well known in the art. Electrodes of electrochemical devices may generally include a base or core made of a material such as stainless steel or titanium. The electrodes may be coated with various materials, for example, iridium oxide, ruthenium oxide, platinum group metals, platinum group metal oxides, or combinations or mixtures thereof. The electrodes typically promote the formation of H⁺ and OH⁻ ions. These ions, along with the ions in the various feeds, are transported by the potential across the electrochemical device. The flow of ions is related to the electrical current applied to the module.

Some embodiments pertain to treating or converting one or more aqueous solutions or process streams to provide, for example, one or more product streams. Product streams may be generated, isolated, aggregated or concentrated. One or more embodiments directed to treating aqueous solutions can involve purifying the aqueous solution to remove one or more undesirable species therefrom. Thus, a product stream may be a purified stream. Other embodiments of the invention can advantageously provide a product formed from a combination of one or more sources. Thus, a product stream, such as an acid or base stream, may be generated by the electrochemical device from one or more precursors supplied thereto. One or more embodiments of techniques can comprise providing one or more aqueous solutions to be processed by removing or migrating one or more species therefrom. The one or more species to be removed or migrated can be one or more cationic and/or one or more anionic species present in feed stream(s). The techniques can further comprise introducing an aqueous solution comprising, for example, a first cation and an associated first anion into one or more compartments of an electrical separation apparatus such as any of the configurations of electrically-driven devices discussed herein. One or more target species can be induced or promoted to migrate from the aqueous solution into one or more concentrating compartments of the isolating or separation apparatus. Further embodiments of the invention may involve promoting the transport or migration of one or more other target species, e.g., an associated species, into one or more depleting compartments of the device. Still further embodiments may involve promoting or migration of one or more additional species into various compartments of chambers of the device.

Likewise, a second aqueous feed, such as one comprising or consisting of DI water, may be provided to one or more compartments of the electrical separation apparatus. The DI water may include a second cation and an associated second anion. These may be induced or promoted to migrate into one or more concentrating or depleting compartments of the device. The first anion may associate with the second cation to form a product stream. Likewise, the first cation may associate with the second anion to form a product stream.

Indeed in some cases, embodiments may include a method comprising one or more steps of introducing an aqueous solution, which comprises a first cation and a first anion, into a first compartment of an electrically-driven apparatus. The method can further comprise one or more steps of providing a second cation and a second anion in a second compartment of the apparatus as well as one or more steps of promoting transport of the ions within the apparatus. For example, the techniques of the invention can thus provide a first product solution comprising the first cation and the second anion concentrated or accumulated in a first compartment. Optional embodiments of the invention can involve one or more steps that promote concentration or accumulation of a second product solution comprising the first anion and the second cation in a second compartment. A first product stream, e.g. a base, may be collected at an outlet of a first concentrating compartment. A second product stream, e.g. an acid, may be collected at an outlet of a second concentrating compartment.

For example, the DI water can be electrolyzed to produce a hydrogen species and a hydroxide species. Where sufficient amounts of such species are provided and transport or migrate, a first concentrating or product compartment can be rendered basic such that liquid contained or flowing therein has a pH of greater than about 7 pH units. Likewise, a second concentrating or product compartment can be rendered to be acidic such that liquid contained or flowing therein has a pH of less than about 7 pH units. Target or precursor ions from a supplied process stream may also migrate. Thus, some embodiments of the invention provide generation of an acid stream and/or generation of a basic stream. One or both may be discarded or recovered, as desired.

In accordance with one or more embodiments, recovering a product stream may involve promoting transport of an ionic species into a concentrating compartment. A basic product stream may be aggregated into a basic concentrating or product compartment. An acidic product stream may be aggregated into an acidic concentrating or product compartment. In some embodiments, generating, isolating or recovering an acid stream may involve promoting transport of an anionic species across an anion-selective membrane. In some embodiments, generating, isolating or recovering a basic stream may involve promoting transport of a cationic species across a cation-selective membrane.

Product streams may be further processed prior to downstream use, upstream use, or disposal. For example, a pH level of a product acid or product base stream may be adjusted. A product stream may be neutralized. In some embodiments, it may be desirable to mix, in part or in whole, one or more product streams. One or more additional unit operations may be fluidly connected downstream of the electrochemical unit. For example, a concentrator may be configured to receive and concentrate a target product stream, such as before delivering it to a point of use. Polishing units, such as those involving chemical or biological treatment, may also be present to treat a product or effluent stream of the device prior to use or discharge.

In accordance with one or more embodiments, the electrochemical device may be operated by applying an electric field across the compartments through electrodes. Operating parameters of the device may be varied to provide desirable characteristics. For example, the applied electric field may be varied in response to one or more characteristics or conditions. Thus, the electric field strength may be held constant or altered in response to a characteristic of the apparatus. Indeed, the one or more operation parameters may be altered in response to one or more sensor measurements, e.g., pH, resistivity, concentration of an ion or other species.

The electric field imposed through electrodes facilitates migration of charged species such as ions from one compartment to another via ion-selective membranes. During operation of some embodiments, a concentrate liquid exits a concentrating compartment and may be directed to an outlet, for example, through a conduit. In embodiments including one or more second concentrating compartments, liquid exiting therefrom may be collected and directed as desired. Liquid exiting a depleting compartment may also be collected and directed.

In accordance with one or more embodiments, one or more compartments of the electrical separation apparatus can be filled with media such as adsorption media, for example, ion exchange media. The ion exchange media, in some embodiments, can include resins such as cation exchange resin, a resin that preferentially adsorbs cations, or an anion exchange resin, a resin that preferentially adsorbs anions, an inert resin, as well as mixtures thereof. Various configurations may also be practiced. For example, one or more compartments may also be filled with only one type of resin, e.g., a cation resin or an anion resin; in other cases, the compartments may be filled with more than one type of resin, e.g., two types of cation resins, two types of anion resins, a cation resin, and an anion resin. Non-limiting examples of commercially available media that may be utilized in one or more embodiments of the invention include strong acid and Type I strong base resins, Type II strong base anion resin, as well as weak acid or weak base resins commercially available from The Dow Chemical Company.

The ion exchange resin typically utilized in the depleting and concentrating compartments can have a variety of functional groups on their surface regions including, but not limited to, tertiary alkyl amino groups and dimethyl ethanol amine. These can also be used in combination with ion exchange resin materials having other functional groups on their surface regions such as ammonium groups. Other modifications and equivalents that may be useful as ion exchange resin material are considered to be within the scope of those persons skilled in the art using no more than routing experimentation. Other examples of ion exchange resin include, but are not limited to, DOWEX® MONOSPHERE™ 550A anion resin, MONOSPHERE™ 650C cation resin, MARATHON™ A anion resin, and MARATHON™ C cation resin, all available from The Dow Chemical Company (Midland, Mich.). Representative suitable ion selective membranes include homogenous-type web supported styrene-divinyl benzene-based with sulphonic acid or quaternary ammonium functional groups, heterogeneous type web supported using styrene-divinyl benzene-based resins in a polyvinylidene fluoride binder, homogenous type unsupported-sulfonated styrene and quarternized vinyl benzyl amine grafts of polyethylene sheet.

In accordance with one or more embodiments, cation exchange and anion exchange resins may be arranged in a variety of configurations within each of the depleting and concentrating compartments. For example, the cation exchange and anion exchange resins can be arranged in layers so that a number of layers in a variety of arrangements can be constructed. Other embodiments or configurations are believed to be within the scope of the invention including, for example, the use of mixed bed ion exchange resins in any of the depleting, concentrating and electrode compartments, the use of inert resins between layer beds of anion and cation exchange resins, and the use of various types of anionic and cationic resins. The resin may generally be efficient in promoting water splitting in one or more compartments. The resin may also be efficient in increasing electrical conductivity in one or more compartments.

The media contained within the compartments may be present in any suitable shape or configuration, for example, as substantially spherical and/or otherwise shaped discrete particles, powders, fibers, mats, membranes, extruded screens, clusters, and/or preformed aggregates of particles, for example, resin particles may be mixed with a binding agent to form particle clusters. In some cases, the media may include multiple shapes or configurations. The media may comprise any material suitable for adsorbing ions, organics, and/or other species from a liquid, depending on the particular application, for example, silica, zeolites, and/or any one or mixture of a wide variety of polymeric ion exchange media that are commercially available and whose properties and suitability for the particular application are well known to those skilled in the art. Other materials and/or media may additionally be present within the compartments that, for example, can catalyze reactions, or filter suspended solids in the liquid being treated.

Further, a variety of configurations or arrangements may exist within the compartments. Thus, one or more compartments of the separation systems of the invention may involve additional components and/or structures such as, but not limited to, baffles, mesh screens, plates, ribs, straps, screens, pipes, carbon particles, carbon filters, which may be used to, in some cases, contain the ion exchange media, and/or control liquid flow. The components may each contain the same type and or/number of the various components and/or be of the same configuration or may have different components and/or structure/configurations.

In operation, a process stream, typically having dissolved cationic and anionic components which may be precursors to a desired acid and/or base product, is introduced into one or more compartments. DI water, a source of hydronium and hydroxyl ions, is also introduced into one or more compartments. An applied electric field across the electrodeionization device promotes migration of ionic species in a direction towards their respective attracting electrodes. Under the influence of the electric field, cationic and anionic components leave one compartment and migrate to another. Ion selective membranes may block migration of the cationic and anionic species to the next compartment. Thus, one or more products generated, at least in part, by association of one or more ionic species within the electrochemical device may become concentrated in one or more compartments thereof. Product streams may exit via outlets associated with the various compartments. A depleted stream may also exit via a compartment outlet.

The electric field may be applied essentially perpendicular to liquid flow within the device. The electric field may be substantially uniformly applied across the compartments, resulting in an essentially uniform, substantially constant electric field across the compartments; or in some cases, the electric field may be non-uniformly applied, resulting in a non-uniform electric field density across the compartments. In some embodiments of the invention, the polarity of the electrodes may be reversed during operation, reversing the direction of the electric field within the device.

In some embodiments, devices and methods involve a controller for adjusting or regulating at least one operating parameter of the device or a component of the system, such as, but not limited to, actuating valves and pumps, as well as adjusting current or an applied electric field. Controller may be in electronic communication with at least one sensor configured to detect at least one operational parameter of the system. The controller may be generally configured to generate a control signal to adjust one or more operational parameters in response to a signal generated by a sensor. The controller is typically a microprocessor-based device, such as a programmable logic controller (PLC) or a distributed control system, that receives or sends input and output signals to and from components of the device or system in which the device is operative. Communication networks may permit any sensor or signal-generating device to be located at a significant distance from the controller or an associated computer system, while still providing data therebetween. Such communication mechanisms may be effected by utilizing any suitable technique including but not limited to those utilizing wireless protocols.

In accordance with one or more embodiments, devices and methods may be implemented to produce an acid or base product. The acid or base product may be generated on demand. The acid or base product may be generated in situ, such as in applications where storage or handling of a chemical may be undesirable, for example, onboard a ship or at a remote facility. An acid or base may be generated based on a downstream demand, such as a demand at a point of use. A point of use may be any type of application. In some embodiments, a downstream demand may involve a chemical operation, manufacturing operation or treatment operation. In at least one embodiment, an electrochemical device may be part of a larger overall system, such as one including one or more upstream and/or downstream operations. In some embodiments, an acid or base product may be used to regenerate an ion exchange bed. In other embodiments, an acid or base product may be used as a catalyst. In some embodiments, an acid or base product may be used as a precursor or reactant to generate another chemical. Generated products may also be used as cleaning agents in various applications or to prepare cleaning agents such as soaps. Acid or base products may be used wherever pH adjustment may be desirable. For example, a generated product stream may be used to treat various waste streams prior to discharge. Product acid and base streams may be used in numerous industries. For example, generated products may find applicability in the pulp and paper industry. Product streams may also be used in the semiconductor industry, such as in chemical mechanical planarization (CMP) and etching processes. Acid and base products may also be involved in the manufacture of plastics, building materials such as plaster, fertilizers and dyes. Acid or base products generated by one or more embodiments of the devices and methods may be used in a variety of additional applications.

Concentration and/or flow rate of one or more process streams may be manipulated based on a downstream demand typically by utilization of one or more controllers described herein. For example, in response to a demand increase, throughput through the electrochemical device may be increased accordingly. Concentration of one or more precursor ions in a process stream supplied to the electrochemical device may also be increased. Flow rate of a process stream containing one or more precursor ions may also be adjusted. Likewise, flow rate of DI water supplying hydrogen and hydroxyl ions may be manipulated in response to changes in product demand. If there is demand for both an acid and a base, both product streams may be recovered. If there is demand only for one product stream, the other may be discarded. Types of process stream and/or types of precursor ions therein supplied to the electrochemical device may be selected and/or adjusted based on a specific product stream to be produced.

It should be understood that the systems and methods of the present invention may be used in connection with a wide variety of systems where the processing of one or more liquids may be desired. Thus, the electrical separation device may be modified by those of ordinary skill in the art as needed for a particular process, without departing from the scope of the invention.

The function and advantages of these and other embodiments will be more fully understood from the following non-limiting example. The example is intended to be illustrative in nature and is not to be considered as limiting the scope of the embodiments discussed herein.

### Example

Laboratory tests were performed using standard and modified versions of a Siemens C-Series continuous electrodeionization (CEDI) module. The goals of the evaluation work were to determine the efficacy of the CEDI process for producing a NaOH product stream from a synthetic mixture of inorganic salts, determine the maximum strength of NaOH product that can be produced—with the intention of reaching up to 18 g/L NaOH, and to evaluate the economics of this application to the cost of purchasing commercial NaOH. The tests were reported during 3 test periods.

### I. Experimental Design

A. Tests 1-13

Tests 1-13 were performed in a C-Series CEDI module from Siemens Corporation. The components are described below.
Aluminum endplate—cathode endplate.
Cathode electrode—iridium oxide coated titanium.
A screen, which was used to make cell type S.
A cationic membrane identified as “c”.
Cell type 1, which utilized a plastic frame and was filled with a 60/40% v/v mix of cationic and anionic resins. The cross section profile of the cell (normal to the flow of current) consisted of 3 chambers in parallel. The two outer chambers were 14″×1.3125″ and the central chamber is 14″×1.25″. The total cross sectional area of the cell was about 54.25″² (350 cm²).
An anionic membrane identified as “a”.
Cell type 2, which was also filled with a 60/40% v/v mix of cationic resin (The same frame was used as in the type 1 cell, but inverted to direct flow to a different duct or manifold system).
A cationic membrane identified as “c”.
Cell type S.
A cationic membrane identified as “c”.
Cell type 1
An anionic membrane identified as “a”.
Cell type 2
A cationic membrane identified as “c”.
Cell type S
Anode electrode—iridium oxide coated titanium.
Aluminum endplate—anode endplate.

Each cell had one of three feed duct options and one of three discharge duct options:
Cell type S was ducted to feed brine and to discharge treated brine. H₂, O₂, and CO₂ gasses evolved in these cells, so those gasses also exited with this stream.
Cell type 1 was ducted to feed DI water and to discharge DI water. The electrical resistivity of the DI water supplied was greater than or equal to about 16 megohm-cm.
Cell type 2 was ducted to feed DI water and to discharge NaOH product. In some cases the feed to cell type 2 was recycled NaOH product, instead of pure DI water.

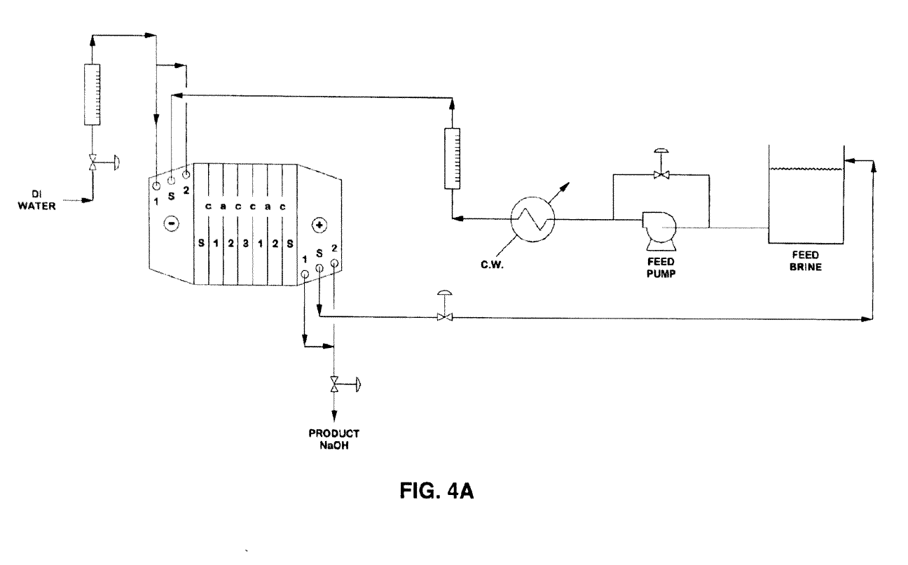

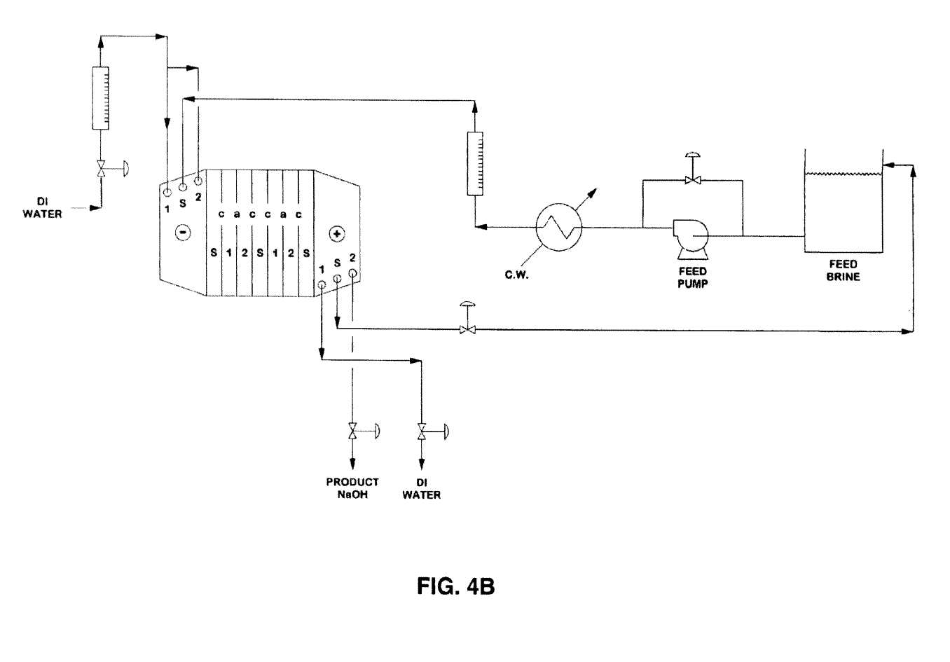

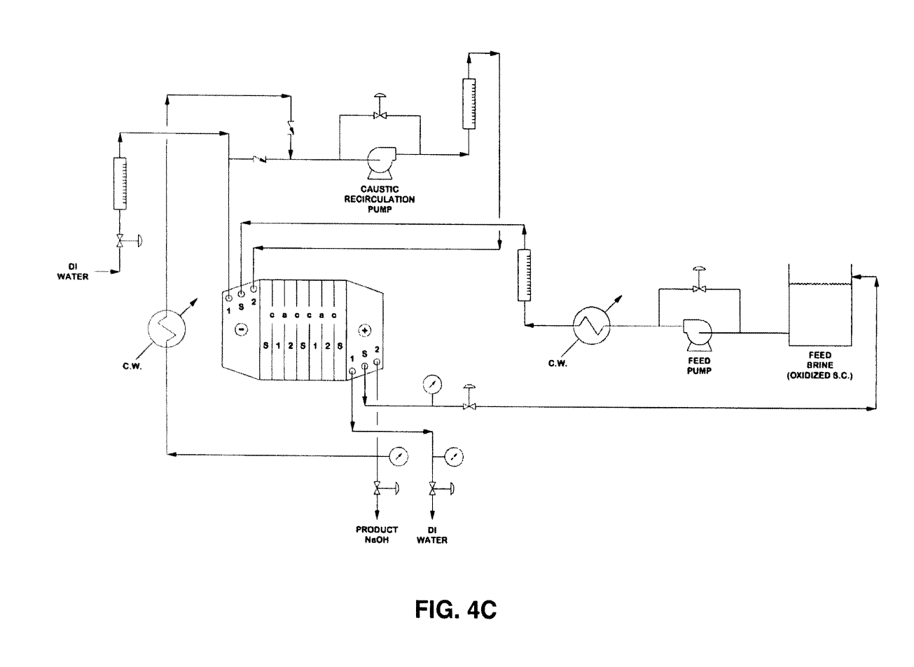

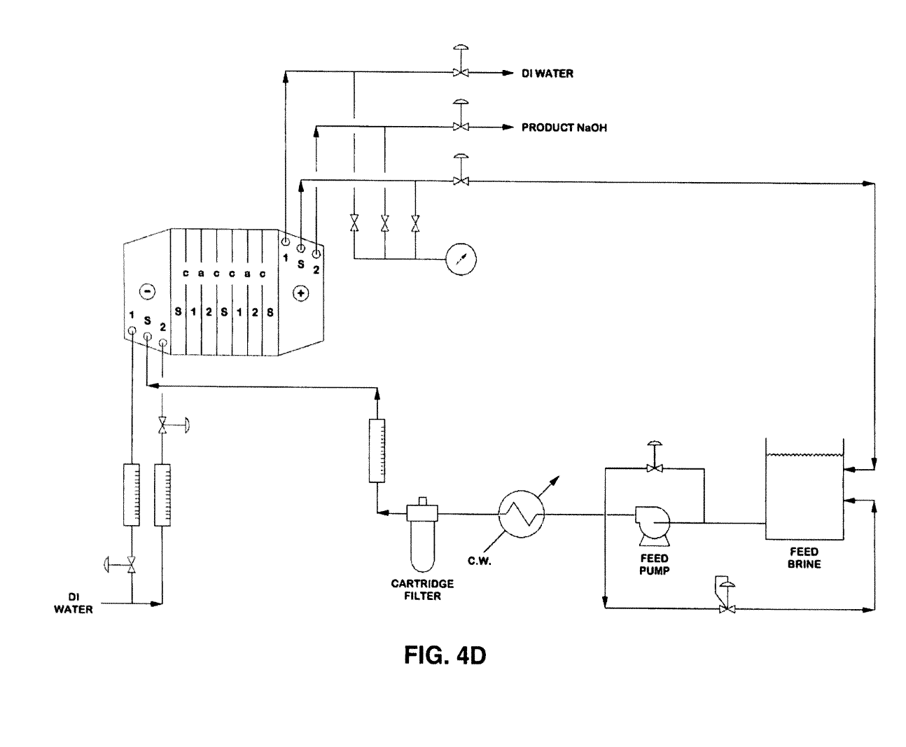

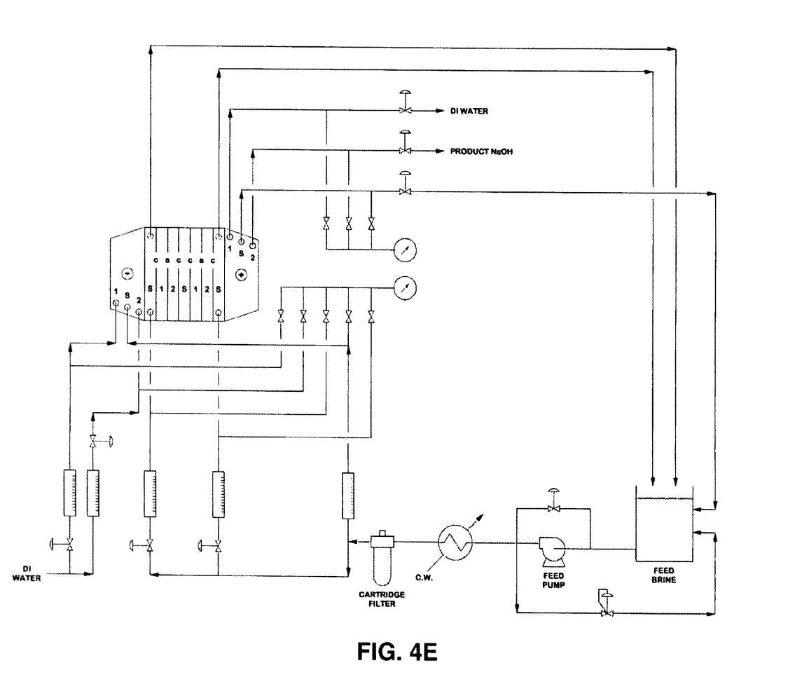

The notation for representing the cell arrangement is: −S12S12S+. The notation for representing the membrane arrangement is −caccac+. In some tests the polarity was reversed, in which case the module became +S21S21S−. Three different plumbing configurations were evaluated, shown in FIGS. 4A-4C, respectively.

Electrical power to the module was provided by a DC power supply and a power controller. The power controller regulated the amperage to the module. The controller displayed voltage and amperage. Wiring was done by connecting the negative (black) wire into the cathode tab and the positive (red) wire into the anode tab. The electrical system was capable of delivering no more than 8 or 9 amperes of power. The wires were 18 gauge and became warm to the touch after a few moments of operation.

Feed flow rates were monitored by the rotameters and effluent flow rates were monitored by use of a cylinder and stopwatch. pH, gas formation rate, and gas composition was not monitored. Formed gases were returned with the recycle brine to the feed tank and were vented by placing a vent hose near the feed tank.

B. Tests 14-17

The plumbing configuration for these tests is shown in FIG. 4D. The equipment was similar to that described above, with the following exceptions:
A larger power supply and electrical cables were used. This supply was connected to a 220 VAC 30A outlet. 8 gauge wiring was used, and these wires remained cool to the touch for all tests. Unlike the prior supply, this one delivered constant voltage, and the resulting amperage was monitored.
New electrodes capable of high current service were used. The electrode plates had heavy titanium terminal tabs and were platinum coated.
One of the cells used a homogeneous membrane, rather than the conventional heterogeneous membrane from IonPure™ (Siemens Corp.).

C. Tests 50-57

Tests 50-57 were conducted with the plumbing configuration shown in FIG. 4E. The equipment was similar to that described in the above prior tests, with the following exceptions:
New electrode plates were used, with titanium mesh electrode plates and built in brine flow ports.
In the prior tests the brine flow to the anode, cathode, and the central screen cell were not independently controllable. To assure that no cells were being bypassed, the module was modified for tests 50-57 by independently controlling flow of each of these streams into their respective cells.
The weave of the screens in the brine cells were arranged diagonally to the fluid flow, rather than parallel and perpendicular. This was done in an attempt to minimize suspected vapor locking in the screens.

### II. Description of Test Procedures

For each experimental run, the feed tank was first filled with the brine. The DI water flow was turned on and the flow adjusted using the rotameter needle valve. The main power was then turned on, which turned on the pumps. Flow rates and system back-pressures were adjusted using various control valves. The DC power controller was energized and adjusted to the various test amperage or voltage. The conductivity and temperature of the feed and each effluent was measured and recorded using an ULTRAMETER 6P II conductivity meter commercially available from Myron L Co. The system was allowed to stabilize for a number of minutes. Stabilization was determined by utilizing the conductivity meter. The amperage and voltage was recorded, and samples of the feed, product NaOH and product brine were collected. For some test runs, multiple samples were collected over a period of time. The module was shut down by turning off the power and stopping the fresh DI water flow.

H₂ and O₂ gases are produced as bubbles in the brine. Fire and explosion hazards were mitigated by venting the brine return lines into a fume hood. No H₂ LEL measurements were collected in this test work.

For tests 3-13, the feed and product samples were analyzed by HACH titration method #8203. The titration was used to measure the NaOH, Na₂CO₃ and NaHCO₃ content. The Na₂SO₄ concentration was measured by photometry using HACH method #8051.

For tests 14-57, the pH level was monitored using the Myron L Co ULTRAMETER. The NaOH, Na₂CO₃, and NaHCO₃ concentrations were monitored by titration using a Metohm 785 DMP Titrino autotitrator.

At the conclusion of test 57, the CEDI membranes were analyzed using a ISI ABT WB-6 scanning electron microscope.

### III. Feed Description

The feed composition was:
55 g/L Na₂SO₄
3.1 g/L Na₂CO₃
35 g/L NaHCO₃

All chemicals used to prepare the feed were reagent grade compounds purchased from Sigma-Aldrich of St. Louis, Mo. DI water was used as the solvent. Tests 11 and 12 used a higher strength feed than listed above, which was prepared by doubling the salts dose and decanting the saturated supernatant from the mix tank. Test 13 used a ¼ strength feed. Tests 50-57 were performed using a solution of 80 g/L Na₂CO₃.

In most cases the feed was recirculated through the CEDI module and back into the feed tank. So the feed sodium concentration was not constant.

### IV. Test Results

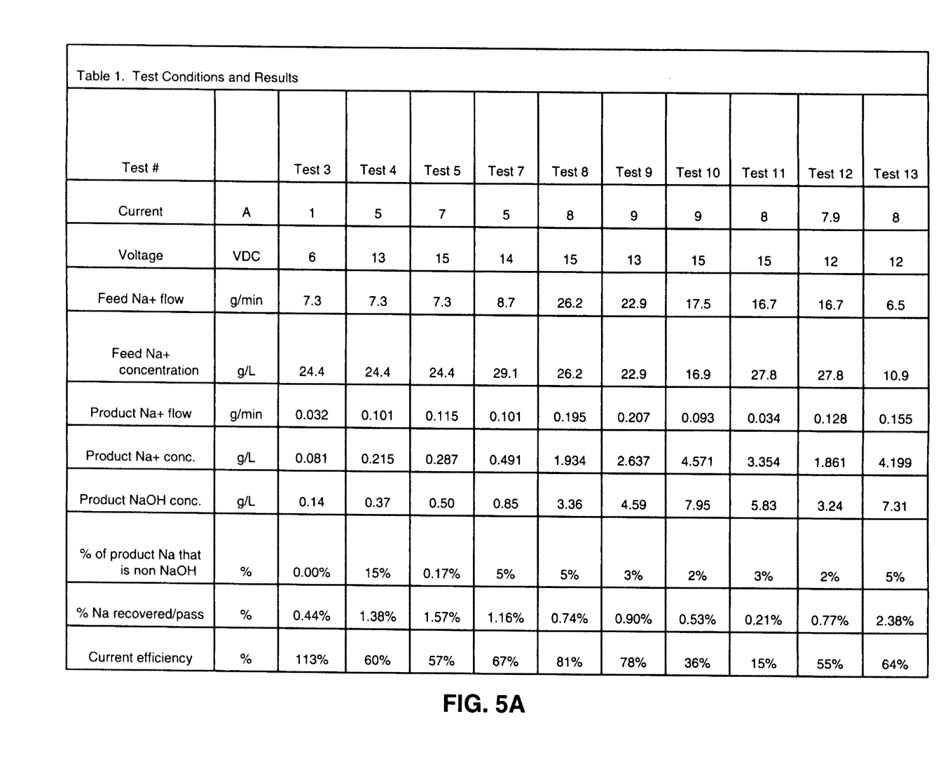

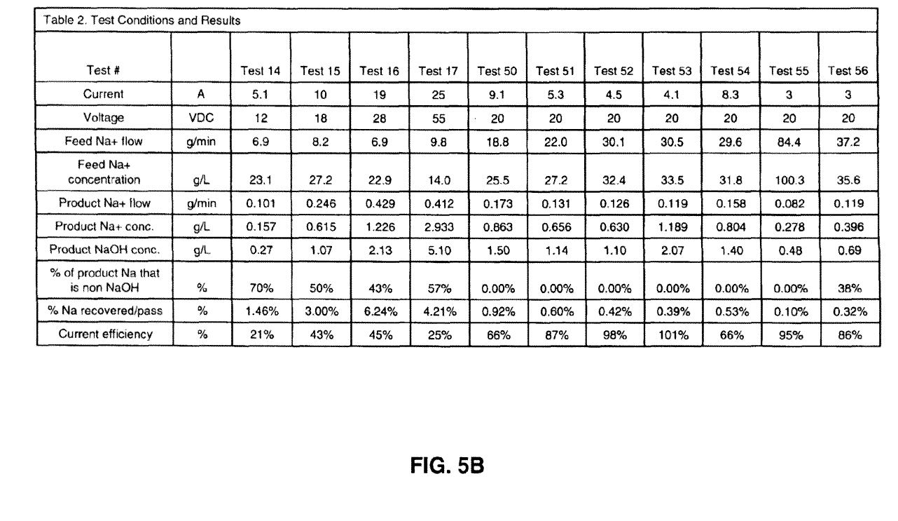

A summary table of the test conditions and results is shown in Tables 1 and 2 presented in FIGS. 5A and 5B, respectively. Test duration was the extent of time it took to record the parameters and collect samples, which was usually 1 to 5 minutes. The reported test time of day was recorded at the end of those steps.

The current efficiency is the fraction of the amperage that was utilized to transport sodium ions into the product NaOH stream. The current efficiency was calculated from Faraday's law, using the following equation.

$$current efficiency = \frac{{FZ}_{Na} {\dot{n}}_{Na}}{{An}_{2}}$$

Where \dot{n}_{Na} is the molar flow rate of sodium in the product NaOH stream (mole Na/second); A is the electrical current (Amp); F is Faraday's constant (96,485 coulomb/mole); n₂ is the number of type 2 cells in the CEDI (in this case, two); Z_{Na} is the charge of a sodium ion, which is +1.

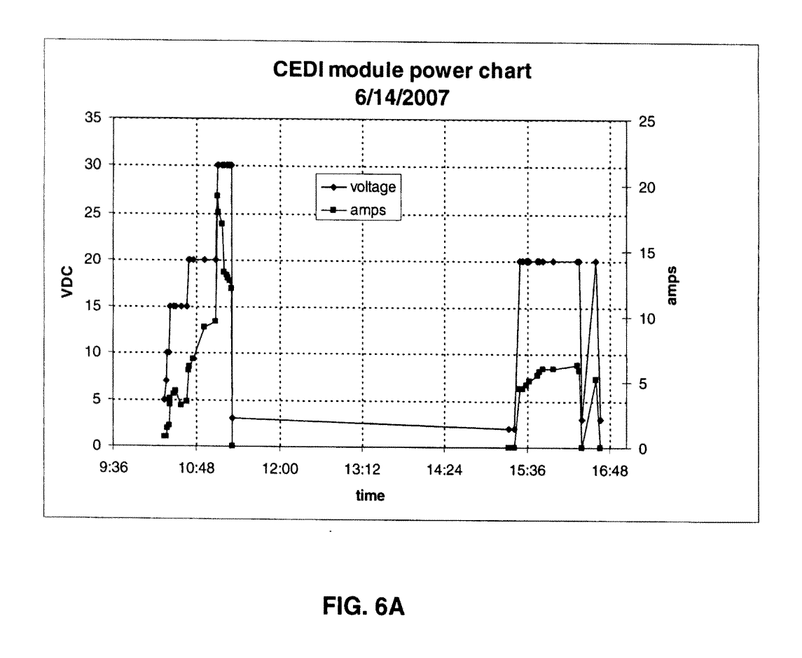

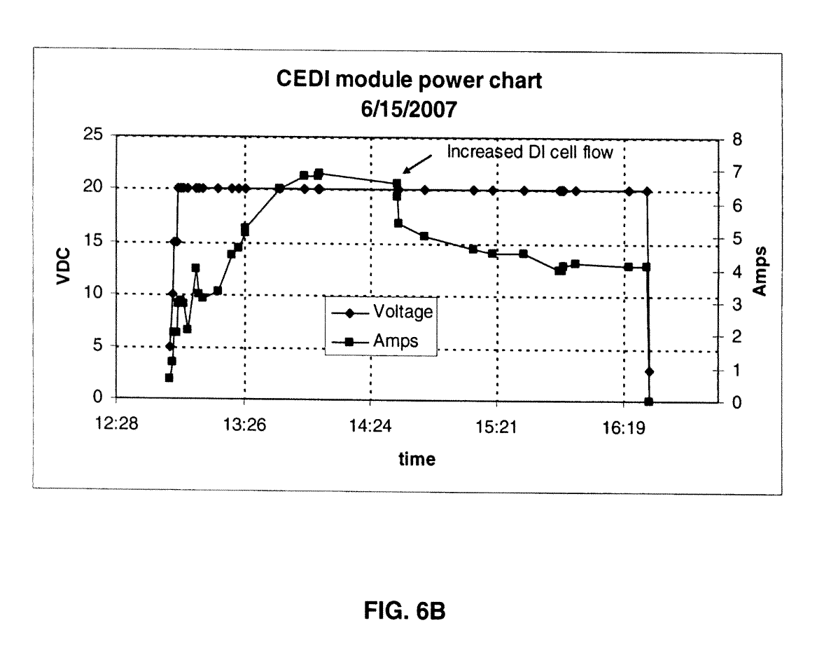

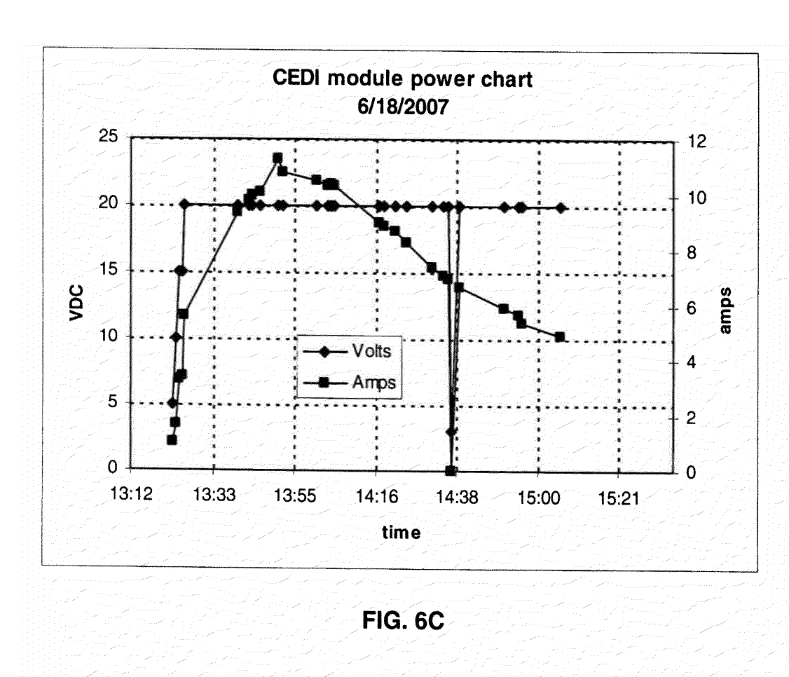

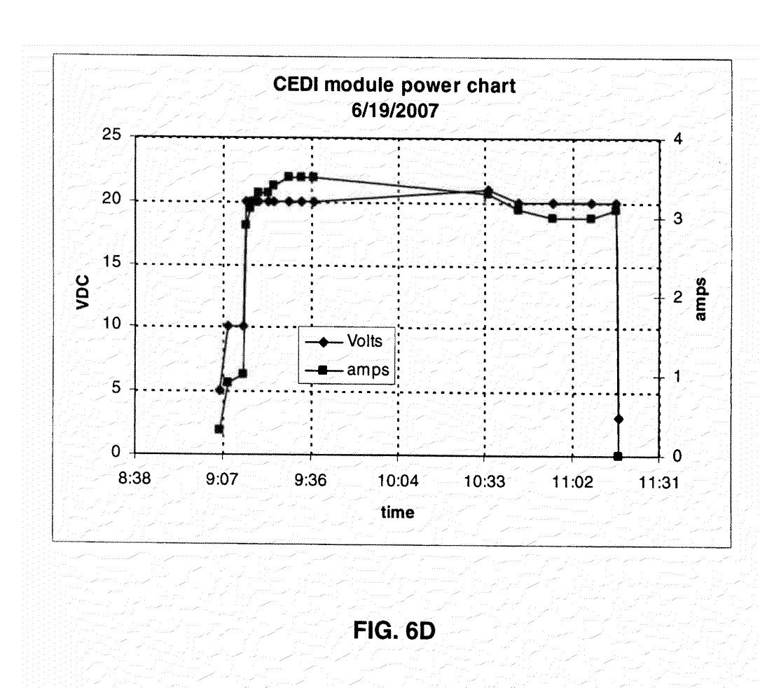

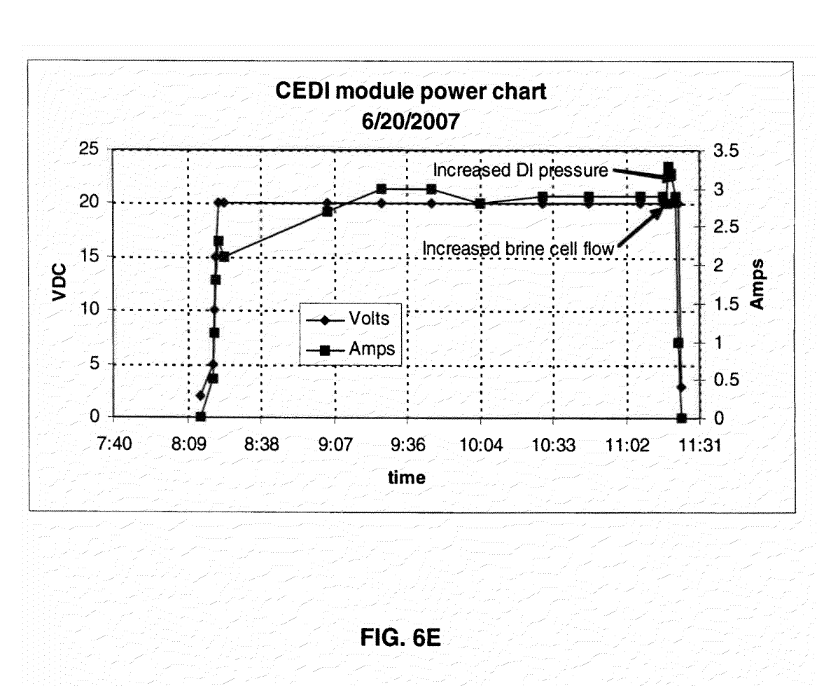

During some of the operations, power charts were recorded to monitor amperage as a function of voltage. These charts are shown in FIGS. 6A-6E. The power charts were recorded during sustained operations at the following nominal conditions as reported in Table 3:

TABLE 3

| | Flow rate | Inlet pressure | Outlet pressure |
|---|---|---|---|
| | (mL/min) | (psig) | (psig) |
| Cathode cell (brine - 1 cell) | 300 | 0 | 0 |
| Anode cell (brine - 1 cell) | 300 | 0 | 0 |
| Screen cell (brine - 1 cell) | 200 | 9 | 0.5 |
| DI outlet (DI feed - 2 cells) | 200 | 2.5 | 2 |
| Caustic outlet (DI Feed - | 200 | 2 | 1 |
| 2 cells) | | | |

At the conclusion of the test work, the module was disassembled. One of the membranes was analyzed by SEM. This membrane separated the brine in the cathode cell from the DI water in the resin bed cell.

### V. Discussion of Test Results

Effectiveness of the CEDI Process on Production of NaOH

All tests showed the CEDI process to be capable of extracting and aggregating sodium ions from the brine and producing a stream of NaOH. The concentration of NaOH in the product streams ranged from 0.14 to 8 g/L NaOH. There was some contamination of the product NaOH, either by carbonates, sulfates, or both during some of the tests run. The purity of the NaOH in the product stream ranged from 30 to 100% pure. The source of contamination may be due to membrane leakage, either from damage or from porosity.

Effect of Increased Amperage

Tests 3, 4, and 5 were identical tests performed at identical conditions, but with increased electrical current with each test. The percent Na recovery and the concentration of Na in the product stream increased with increasing current. The effluent temperature also increased. The current efficiency decreased with increasing current. Decreasing current efficiency resulted in inefficient utilization of power and results in temperature increase.

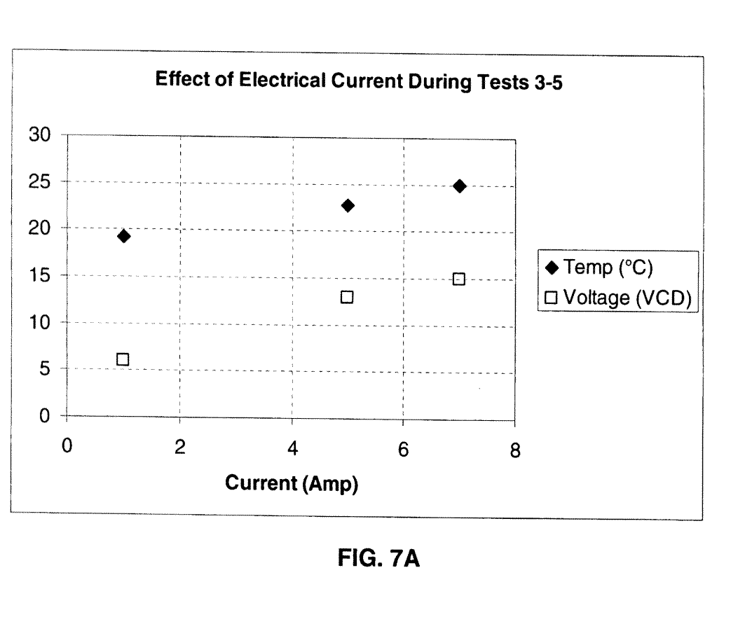

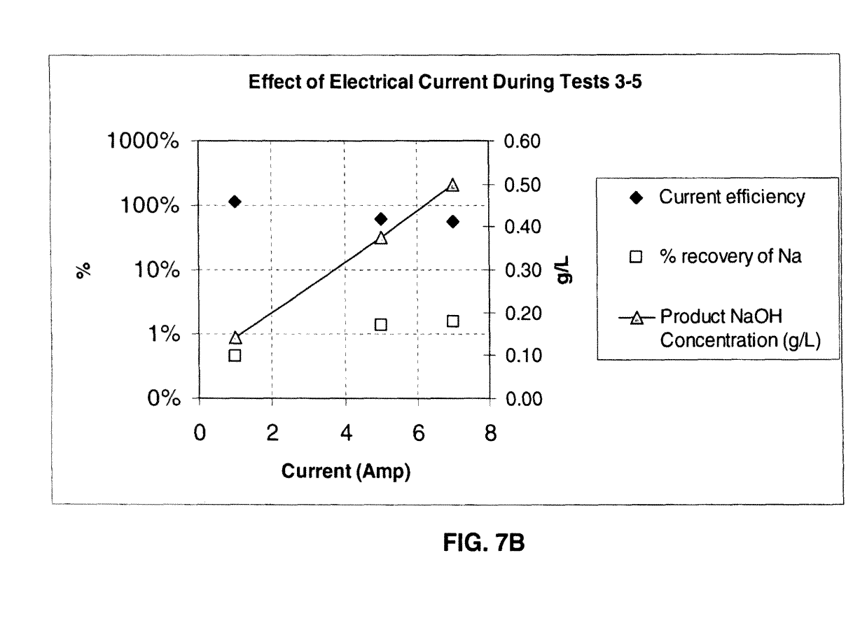

Results are shown graphically in FIGS. 7A and 7B.

During tests 14-57, operated at higher current, it was observed that the high amperage caused a loss of performance with time. This is shown in FIGS. 6A-6E, which shows the dynamic behavior of the current at high voltage. FIG. 6C shows upon unit start-up, the amperage initially increased with time. This was due to NaOH formation in the product cell, which increased conductivity and thus amperage, at fixed voltage. At approximately 13:50 the current reached a maximum at 11 amps. After this, current steadily declined.

The system was subsequently operated with independently controlled flow and pressure capabilities to certain suspect cells in order to reduce or eliminate potential vapor locking, where formed H₂, O₂, and CO₂ gases might be collecting as stationary bubbles. Also, sodium carbonate was substituted as the feed in order to reduce or eliminate CO₂ gas production from Na⁺ removal. Reduction of current over time was observed.

Effect of Caustic Flow Rate

Tests 11 and 12 were performed with similar feed and amperage. In these tests the NaOH product stream was recycled through cell type 2. Product NaOH exited the system through a small purge stream, which was replenished by DI water (i.e. feed and bleed). In this way, the flow rate of the stream across the cell was maintained high, but the overall residence time was increased to produce a smaller flowing stream of higher strength product.

Test 12 had a higher product discharge rate, and thus shorter caustic retention time. These tests were otherwise identical. The shorter retention time resulted in a weaker NaOH product stream, however the % Na recovery was 4 times higher than in test 11 and the current efficiency was also higher. These results imply longer caustic residence time can increase the strength of product, but may reduce overall Na recovery and electrical efficiency. This may be due to the high osmotic pressure of the caustic stream resisting transport of more Na⁺ ions and may be overcome by using higher applied currents.

Effect of Brine Concentration

Test 13 was conducted at similar conditions as in test 12, but with a lower strength (Na+ concentration) feed brine. Test 13 was performed with carefully controlled differential pressure between cells, in an attempt to minimize cell/cell leakage. Test 13 was also conducted at a lower product discharge rate from cell type 2, in which a lower current efficiency and sodium recovery was expected prior to conducting this test. Surprisingly, this test showed better current efficiency and higher % Na recovery than test 12. It appears that using a weaker strength feed brine enhanced the sodium recovery.

Resin Effect

Test 7 was performed at similar conditions to test 4. Test 4 had a resin filled feed cell in the middle of the CEDI, while in test 7, this middle cell was filled with a screen. Test 7 feed was a higher strength feed, which would also have had an impact on results, making review difficult, since two parameters are different. Based on the test 13 analysis, the higher strength feed brine was expected to produce a lower current efficiency, however in the test 7 to test 4 comparison, the current efficiency was surprisingly approximately the same. This implies that replacing the resin with a screen does not diminish the efficiency of the process. All subsequent tests were performed with screens in the brine cells.

Membrane Discussion

A homogeneous membrane was used during tests 14-16. These tests had the highest extent of contamination of the product. It is unclear if this was due to porosity/diffusion, or if there was a tear in the membrane.

Effect of Increasing Brine Flow Rate

Tests 8 and 12 were similar tests. Test 8 was conducted with higher brine and caustic flow rates than test 12. The current efficiency of test 8 was higher than 12 and the product caustic strength was similar. These results may indicate that the higher flow rate of brine increases efficiency.

Off-Gas Discussion

The process produced an off-gas in the brine recycle line. The off-gas formation rate and composition was not measured. By visual inspection, there was a significant gas flow in the return line which increased amperage. The gas comprised primarily hydrogen and oxygen, formed on the electrodes. CO₂ gas also evolved in tests that had NaHCO₃ in the feed, but no Na₂CO₃.

Scanning Electron Microscope (SEM) Results

Numerous different cell packs were tested in this evaluation. After the last test was complete, the last cell pack was cut open and samples of the membranes were retained. The cationic membrane separating the cationic cell from the DI water cell was dried, gold sputtered, and placed in an SEM for analysis. The brine side image showed what appeared to be resin particles suspended in the polyethylene sheet matrix. The cavities were larger than the particles, which is to be expected since the particles shrunk during the drying process, which was necessary in the sample preparation for the SEM. The DI water side appears similar, however it appears that the sheet matrix is different and may indicate damage.

DI Water Discussion

Over the course of tests 17-57, adjustments to the DI water were observed to cause an effect. At constant conditions, increasing DI water flow rate decreased the current (FIG. 6B). Similarly, increasing the relative pressure of the DI caused a decrease in current. Related to this, in some cases it was observed that increasing the brine pressure or flow would increase current (FIG. 6E). The decrease in current may be a result of a water splitting reaction producing H⁺ and OH⁻ ions in solution and in the resin bed. This may increase conductivity, and at higher DI water flow rate, these ions are washed out, decreasing conductivity. Alternatively, or in conjunction with water splitting, the ions from the brine and caustic cells may leak through the membranes into the DI water cell, which increases conductivity. Similarly, increasing DI water flow may wash out these ions more quickly. Increasing relative DI water pressure generally decreases the leak rate. Leaks may not easily be detected, however, since by the time the DI water is discharged, contaminant ions are removed by the CEDI process.

### VI. Results

The efficacy of CEDI for recovering Na⁺ as NaOH from oxidized spent caustic has been proven. Higher recovery, such as 10% Na is achievable by using a recycle. High amperage may be needed in order to produce high strong caustic at desirable flow-rates.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. An electrochemical device, comprising:
a first concentrating compartment at least partially defined by a first anion-selective membrane and a second anion-selective membrane;
an electrolyzing compartment at least partially defined by the second anion-selective membrane and a cation-selective membrane; and
a second concentrating compartment at least partially defined by the cation-selective membrane and a third anion-selective membrane.

2. The device of claim 1, further comprising a source of deionized water fluidly connected to the electrolyzing compartment and the second concentrating compartment.

3. The device of claim 2, further comprising a source of an ionic species fluidly connected to the first concentrating compartment.

4. The device of claim 3, wherein the source of the ionic species comprises a salt solution.

5. The device of claim 4, wherein the salt solution comprises an acid or base precursor.

6. The device of claim 1, wherein at least one of the first concentrating compartment, the second concentrating compartment and the electrolyzing compartment comprises ion-exchange media.

7. The device of claim 6, wherein the ion-exchange media comprises a mixed resin bed, a cation resin bed or an anion resin bed.

8. The device of claim 1, further comprising an acidic solution outlet.

9. The device of claim 8, further comprising a basic solution outlet.

10. An electrochemical device, comprising:
a first concentrating compartment at least partially defined by a first cation-selective membrane and a second cation-selective membrane;
a second concentrating compartment at least partially defined by the second cation-selective membrane and an anion-selective membrane; and
an electrolyzing compartment at least partially defined by the anion-selective membrane and a third cation-selective membrane.

11. The device of claim 10, further comprising a source of deionized water fluidly connected to the electrolyzing compartment and the second concentrating compartment.

12. The device of claim 11, further comprising a source of an ionic species fluidly connected to the first concentrating compartment.

13. The device of claim 12, wherein the source of the ionic species comprises a salt solution.

14. The device of claim 13, wherein the salt solution comprises an acid or base precursor.

15. The device of claim 10, wherein at least one of the first concentrating compartment, the second concentrating compartment and the electrolyzing compartment comprises ion-exchange media.

16. The device of claim 15, wherein the ion-exchange media comprises a mixed resin bed, a cation resin bed or an anion resin bed.

17. The device of claim 10, further comprising an acidic solution outlet.

18. The device of claim 17, further comprising a basic solution outlet.

19. A method of operating an electrochemical device, comprising:
introducing a cationic species and an anionic species into a first concentrating compartment of the electrochemical device;
introducing deionized water into a second concentrating compartment and a depleting compartment of the electrochemical device;
electrolyzing deionized water in the depleting compartment; and
recovering an acid stream at an outlet of the first concentrating compartment.

20. The method of claim 19, wherein recovering the acid stream comprises promoting transport of the anionic species across an anion-selective membrane.

21. The method of claim 19, further comprising recovering a basic stream at an outlet of the second concentrating compartment.

22. The method of claim 21, wherein recovering the basic stream comprises promoting transport of the cationic species across a cation-selective membrane.

23. The method of claim 19, further comprising adjusting a pH level of the acid stream downstream of the electrochemical device.
